(19) United States
(12) Patent Application Publication
(10) Pub. No.: US 2009/0266269 A1
(43) Pub. Date: Oct. 29, 2009

(54) Non-toxic paint additive

(76) Inventors: Kwang Kook Lee, Los Angeles, CA (US); Shin Jong Chang, Los Angeles, CA (US)

Correspondence Address: Eugene Oak, 610 S. Van Ness Ave., Los Angeles, CA, 90005, US

(21) Appl. No.: 12/150,036

(22) Filed: Apr. 23, 2008

(51) Int. Cl. C09C 1/36

(52) U.S. Cl. 106/439

(57) ABSTRACT

A household wall non-toxic paint additive comprised of mixture of solvent-soluble compounds, which fine granulated from available mineral composition, with dipole properties, in which aromatic oils can be added to the paint additive is enclosed in this current application. This nontoxic paint additive makes for a type of special painting material, in the current application, is non-harmful for man.

### FIELD OF THE INVENTION

The present application is a paint additive designed for coating walls with non-harmful materials. The invention is related to coating compositions primarily for a refinish on walls for added bulky coating for a smoother surface finish. This extra coating includes dipole particulates and material from group mineral compounds and optional aromatic oils

### BACKGROUND OF THE INVENTION

Wall paint materials usually consists of compounds that are harmful for man. Such paints are composed of ketone, which is water soluble due to its ability to make hydrogen bonds but very volatile, and is potentially harmful for man and the environment. Ketone compounds are usually very unpleasant in odor and prolonged inhalation of such compound can lead to symptoms, such as headaches, vertigo, etc. in addition these harmful compounds tend to remain inside the home's air long after the wall has been painted and initial smells have dissipated, so the resident is exposed to these harms unaware.

Another aspect of this current application is the properties of the additive to the paint. The added compounds to the paint contain inherent dipoles and this property is beneficial for use in water soluble paints. The water solubility ensures uniform mixture and texture of the filler and the paint without the need of elaborate mixing. Most commercially available wall paints have additives added to the product but the addition of a filler can be very difficult due to the paint material composition. Even a well-mixed paint mixture does not guarantee long-term results once applied to the wall. Problems are cracking and rupture of the dried filler, uneven densities of the filler, and the toxic chemicals that can potentially be released during the cracking and rupture of the additives.

Another property of the filler from the current application is its ability to create a very fine sandpaper-like surface as the water from the fresh paint evaporates. As solvent evaporates from the paint the overall volume of the paint will decrease. However, the dry paint mixture leaves neither cracks nor fractures as the filler density is uniform throughout the paint. As water evaporates the paint leaves out a faintly rough surface throughout the wall, which is more aesthetically pleasant for sight and touch. The mixture can very well be used to cover cracks and fractures from previous paintings.

The sandpaper-like appearance is to give the painted wall a larger surface area for pluralities of uses. The dipole properties of the additive mixture can be used to trap very small dust particles, pollen, mold spores and animal dander that can float at the painted wall's vicinity. The trapping can be possible because the paint additive composition promotes negative ionization of the air near the wall, and effectively purifies the air in the room. When the paint additive is combined with aromatic oils the increased surface area helps to emit more aromatic scent to the room.

### DETAILED DESCRIPTION OF THE PREFERRED EMBODIMENT

The non-toxic paint additive is comprised of mineral compounds when granulated are the size under 325 Mesh. The fine grain has a very dust-like appearance and feel to the touch. The small size of the grain is necessary for proper mixing with the solvent, including but not limited to water-soluble, paint. Lager grain size would make mixing a difficult effort and would have to be done in a continuous manner. Continuous mixing would be required from keeping the non-toxic paint additive from sinking to the bottom of the container.

Good and uniform mixture is essential for the paint using this additive because a purpose of the paint is to add volume while maintaining harmful substances as low as possible. In a bad mix once the applied paint dries up the wall will eventually crack, leaving an unpleasant aesthetic appearance. The fine grain makes the non-toxic paint additive well suited to fill the voids created by cracks. A simple pass of the paint brush or roll is enough to mask the crack.

The non-toxic paint additive is a mixture composed of dipole compounds in the majority. The dipole aspect of the non-toxic paint additive ensures solvent solubility and no other chemicals are needed for mixing. Without any toxic chemicals the non-toxic paint additive is health friendly for job that requires any significant amount of time and effort to finish. Any non-water-soluble compounds of the non-toxic paint additive can also be implemented to as filler to voids formed by cracks.

The non-toxic paint additive dipole property from the water-soluble compounds is also very helpful at maintaining low indoor air pollution as the dipole can attract any minute size dirt particle. Dirt trapping is obviously possible with the majority of the mass of the non-toxic paint additive mixture being water-soluble compounds in the form of silica. With the increased surface area as the paint dries these dust particles can be removed from the walls for some extended period of time. If the paint additive is augmented with aromatic oils then the increased surface area permits emission of the pleasant scents. Since oil is hydrophobic the dipole effect of the additive remains unaltered.

Several analysis of the non-toxic paint additive yielded the following results:

TABLE 1

| Compound | Chemical | |
|---|---|---|
| Name | Formula | Mass Composition |
| Silicon Dioxide | Si0₂ | from 66.65% to 72.20% |
| Iron (III) Oxide | Fe₂O₃ | from 4.45% to 4.85% |
| Aluminum Oxide | Al2O3 | from 11.50% to 12.45% |
| Titanium(IV) | TiO₂ | from 0.60% to 0.65% |
| Oxide | | |
| Calcium Oxide | CaO | from 1.85% to 2.00% |
| Magnesium | MgO | from 0.60% to 0.65% |
| Oxide | | |
| Potassium Oxide | K2O | from 3.80% to 4.10% |
| Sodium Oxide | Na₂O | from 1.00% to 1.10% |
| Carbon | C | from 2.00% to 9.55% |

From the results from Table 1 none of the compounds found from the analysis are volatile. The non-toxic paint filler is mostly comprised of silica and oxides from non-toxic minerals. Silica makes up for the majority of the overall mass of the non-toxic paint additive mass, and the majority of the water-soluble aspect of the non-toxic paint additive. Potassium oxide, sodium oxide, and calcium oxide are known to react in water with potassium oxide known for having a violent reaction with water, but at very small mass quantities their reactance is not harmful for man.

Although this invention has been described with particular reference to water-soluble paints, there is no reason why this additive cannot be used in other types of paints with a variety of solvents, or whether they are toxic or non-toxic. While the current application describes in preference for non-toxic and water-soluble paints, it is up to the skilled in the art that various changes and modifications maybe made therein without departing from the spirit and scope thereof. The applied claims are intended to cover all such modifications and changes.

What is claimed is:

1. A non-toxic paint additive material is added to a paint mixture composed of:
66.65% to 72.20% by weight Silicon dioxide (SiO₂); and,
4.45% to 4.85% by weight Iron(III) Oxide (Fe₂O₃); and,
11.50% to 12.45% by weight Aluminum Oxide (Al₂O₃); and,
0.60% to 0.65% by weight Titanium(IV) Oxide (TiO₂); and,
1.85% to 2.00% by weight Calcium Oxide (CaO); and,
0.60% to 0.65% by weight Magnesium Oxide (MgO); and,
3.80% to 4.10% by weight Potassium Oxide (K₂O); and,
1.00% to 1.10% by weight sodium Oxide (Na₂O).

2. The mixture in claim 1 has particulates with negative ionization of an enclosure when dried on an exposed surface.

3. The non-toxic paint additive in claim 1; whereas, the grain size is 325 mesh or less.
